(19) United States
(12) Patent Application Publication
(10) Pub. No.: US 2024/0030642 A1
(43) Pub. Date: Jan. 25, 2024

(54) Connector Assembly and Electronic Device Including the Same

(71) Applicant: Tyco Electronics AMP Korea Co., Ltd., Gyeongsan (KR)

(72) Inventors: Sung-Chul Kim, Gyeongsan-Si (KR); Byung-Hee Cho, Gyeongsan-Si (KR); Suk-Eun Jung, Gyeongsan-Si (KR); Ki Deok Cheon, Gyeongsan-Si (KR)

(73) Assignee: Tyco Electronics AMP Korea Co., Ltd., Gyeongsan (KR)

(21) Appl. No.: 18/355,002

(22) Filed: Jul. 19, 2023

(30) Foreign Application Priority Data
Jul. 21, 2022 (KR) 10-2022-0090387

(51) Int. Cl. H01R 13/436

(52) U.S. Cl. CPC H01R 13/4361

(57) ABSTRACT

A connector assembly comprises a body and an elastic terminal position assurance (TPA) member. The body includes a plurality of contacts and defines a coupling groove exposing some of the plurality of contacts. The TPA member includes a hinge portion and a latch, and is adapted to indicate whether the plurality of contacts are sitting at designated positions. The hinge portion is hinged with respect to the body on one end of the TPA member. The latch is formed such that the other end of the TPA member engages with the coupling groove.

### CROSS-REFERENCE TO RELATED APPLICATIONS

This application claims the benefit of Korean Patent Application No. 10-2022-0090387 filed on Jul. 21, 2022, in the Korean Intellectual Property Office, the entire disclosure of which is incorporated herein by reference for all purposes.

### FIELD OF THE INVENTION

The present invention relates to a connector assembly including a terminal position assurance (TPA) and an electronic device including the connector assembly.

### BACKGROUND

A connector is a type of electric component that selectively allows or disallows electrical connection. The connector may include a plurality of contacts. In a process of assembling the connector, a contact may be separated from the connector when the contact has not been completely inserted into the housing of the connector, or when a wire connecting to the contact is pulled back by vibration or the like while the connector is being used. Such separation of the contact from the connector may cause problems, such as poor connection. Accordingly, in the process of assembling the connector, a terminal position assurance (TPA) member may be provided to identify, or indicate to a user, whether a contact is incompletely assembled or inserted into the housing.

### SUMMARY

According to an embodiment of the present disclosure, a connector assembly comprises a body and an elastic terminal position assurance (TPA) member. The body includes a plurality of contacts and defines a coupling groove exposing some of the plurality of contacts. The TPA member includes a hinge portion and a latch, and is adapted to indicate whether the plurality of contacts are sitting or arranged at designated positions. The hinge portion is hinged with respect to the body on one end of the TPA member. The latch is formed such that the other end of the TPA member engages with the coupling groove.

### BRIEF DESCRIPTION OF THE DRAWINGS

The invention will now be described by way of example with reference to the accompanying Figures, of which:

FIG. 1 is a perspective view of a connector assembly according to an embodiment of the present disclosure;

FIG. 2 is an exploded perspective view of the connector assembly of FIG. 1;

FIG. 3 is an exploded perspective view illustrating a state in which a TPA member is opened in the state of FIG. 2;

FIG. 4 is a perspective view of a plug of FIG. 3 for illustrating a first TPA member;

FIG. 5 is a cross-sectional view of FIG. 4;

FIG. 6 is a perspective view of a plug for illustrating a first TPA member, according to another embodiment;

FIG. 7 is a perspective view of a cap of FIG. 3 for illustrating a second TPA member;

FIG. 8 is a cross-sectional view of FIG. 7;

FIGS. 9A and 9B are cross-sectional views illustrating an operation of a TPA member;

FIG. 10 is a perspective view of a cap for illustrating a second TPA member, according to another embodiment; and

FIG. 11 is a cross-sectional view of FIG. 10.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

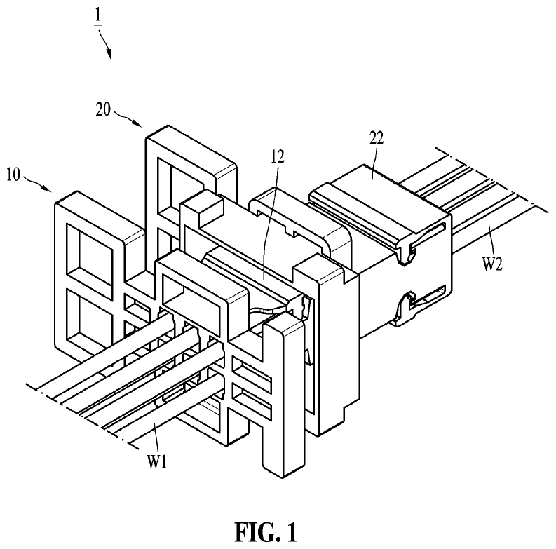

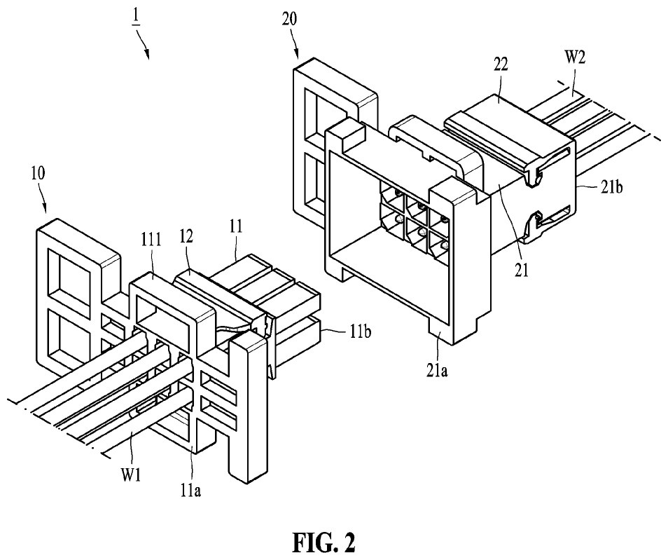

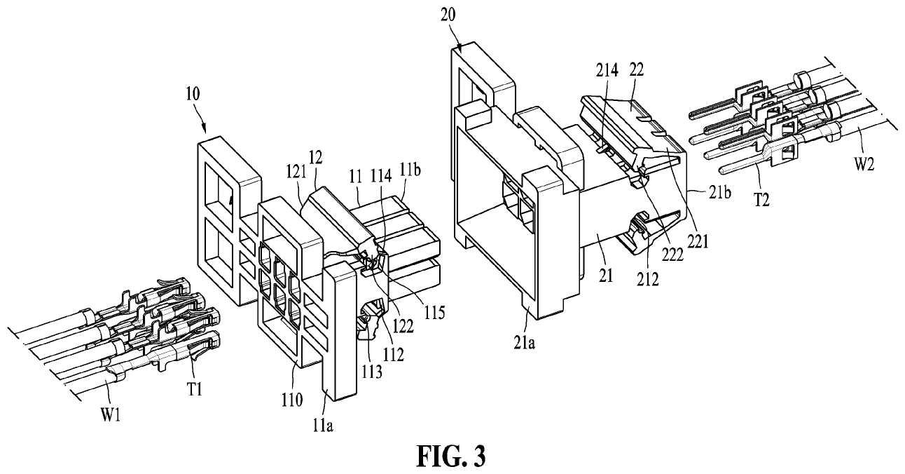

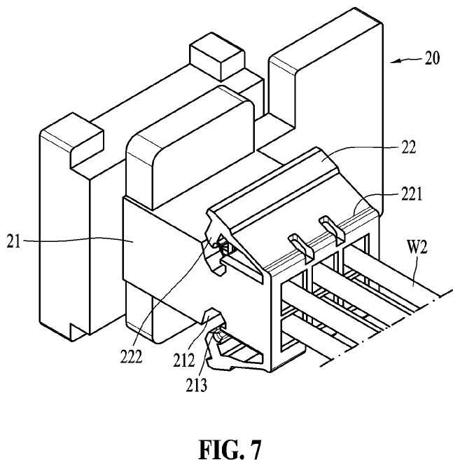

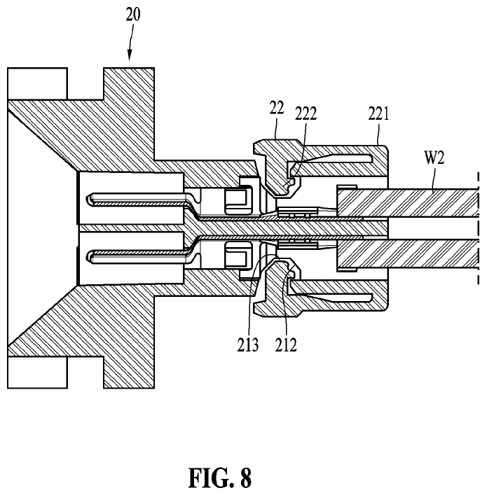

A connector assembly 1 according to embodiments is described with reference to FIGS. 1-11. Referring to the figures, the connector assembly 1 may include a plug 10 and a cap 20 that couple to each other and have a plurality of contacts. The plug 10 may include a plug body 11 accommodating a plurality of first contacts (hereinafter, referred to as receptacle contacts T1). The cap 20 may include a cap housing 21 accommodating a plurality of second contacts (hereinafter, referred to as tab contacts T2). The cap housing 21 may be formed with the plug 10 and may be inserted into and coupled to the cap 20. When the plug 10 couples to the cap 20, the plurality of receptacle contacts T1 correspond to or engage with the plurality of tab contacts T2, respectively, and electrically couple to the plurality of tab contacts T2.

In the following description, a first end 11a may refer to an end of the plug body 11 on the side where the plurality of contacts T1 are inserted into the plug body 11 and a second end 11b may refer to an end of the plug body 11 on the side that is opposite to the first end 11a and couples to the cap housing 21. Similarly, a first end 21a may refer to an end of the cap housing 21 on the side where the plug 10 couples to the cap 20, and a second end 21b may refer to an end of the cap housing 21 on the side that is opposite to the first end 21a and in which the plurality of tab contacts T2 are inserted into the cap housing 21. In addition, the plug 10 and the cap 20 are described in up, down, left, right, front, and rear directions, respectively, based on the state illustrated in the diagrams.

In the diagrams, W1 and W2 may denote wires coupling to the receptacle contacts T1 and the tab contacts T2, respectively. In addition, the plug 10 and the cap 20 may include terminal position assurance (TPA) members 12 and 22, respectively, such that the position of the receptacle and tab contacts T1 and T2 may be confirmed or identified.

First, the TPA member 12 (hereinafter, referred to as a first TPA member 12) provided in the plug 10 is described. The plug body 11 may be formed with a coupling groove 112 to expose some of the receptacle contacts T1. The coupling groove 112 may be formed with a locking bump or protrusion 113 that engages with the first TPA member 12. One end of the first TPA member 12 may be hinged with respect to and fixed to the plug body 11. The other end of the first TPA member 12 may be formed as a free end that extends toward the second end 11b such that a latch 122 may be formed to engage with the locking bump 113 of the coupling groove 112. The first TPA member 12 may have its own elasticity.

A hinge portion 121 of the first TPA member 12 may be fixed to an outside wall 111. The outside wall 111 may be exposed to the outside when the plug 10 couples to the cap 20. In an example, the outside wall 111 may be formed with a movable portion 121a that is formed by cutting a portion that couples to the hinge portion 121 of the first TPA member 12 to form a predetermined rip, break-away or tear-away portion defined by lateral slits formed through the outside wall. According to this embodiment, as the hinge portion 121 is formed with the movable portion 121a, the hinge portion 121 and the first TPA member 12 may be elastically transformed in a more flexible manner.

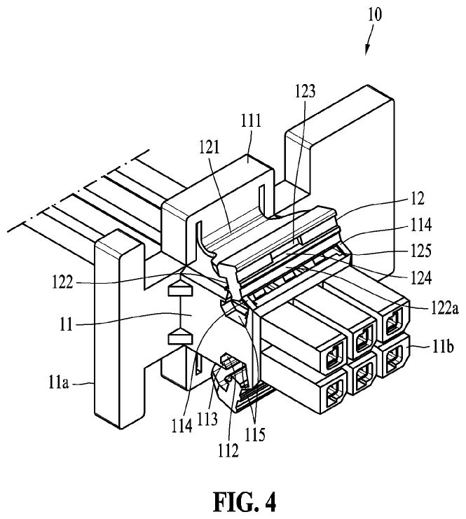

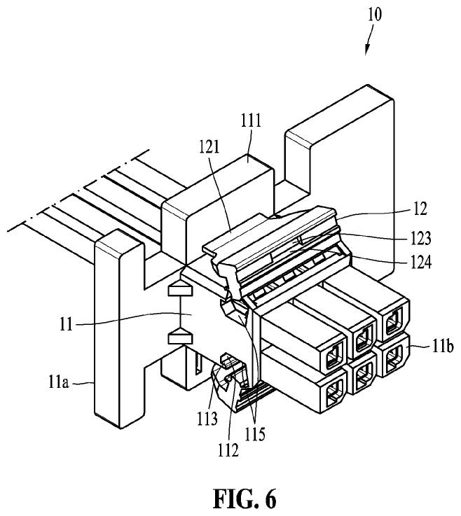

Alternatively, as shown in FIG. 6, the hinge portion 121 may be fixed without forming a rip or break-away portion on the outside wall 111. A detailed description of the first TPA member 12 illustrated in FIG. 6 is omitted as the first TPA member 12 in FIG. 6 is substantially the same as the first TPA member 12 described with reference with FIG. 4, except that no rip is formed on the outside wall 111.

In addition, the hinge portion 121 of the first TPA member 12 may be formed to incline at a predetermined angle with respect to the surface of the plug body 11. According to the present embodiment, the first TPA member 12 may be formed to have an inclination with respect to the plug body 11 such that when the first TPA member 12 is pressed, the first TPA member 12 may be rotated to a locked position where the first TPA member 12 is inserted into the coupling groove 112. In addition, as the first TPA member 12 has its own elasticity, the first TPA member 12 may transform or deform, flexibly pass over the locking bump 113, and be inserted into the coupling groove 112. At the final locked position where the latch 122 completely couples to the locking bump 113, the latch 122 may apply force over the locking bump 113, thereby preventing the first TPA member 12 from being unlocked.

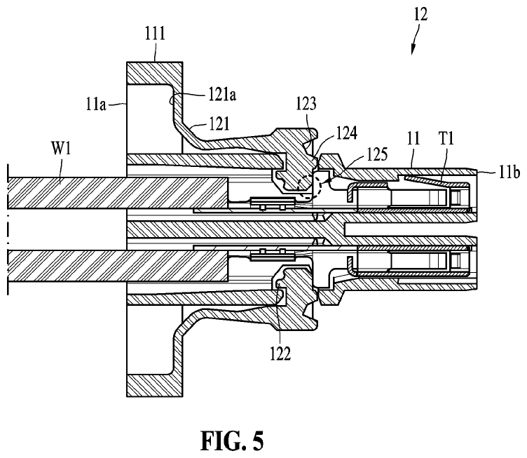

When the latch 122 engages with the locking bump 113, as shown in FIG. 5, a head portion 122a opposite the latch 122 with respect to the locking bump 113 may contact the receptacle contact T1 inside the coupling groove 112. The latch 122 may press and contact the receptacle contact T1 and be positioned to press the receptacle contact T1 in a direction opposite to the direction where the receptacle contact T1 is separated from the plug body 11 such that the receptacle contact T1 may be prevented from being disengaged from the plug body 11 and may remain at a designated position.

In addition, the first TPA member 12 may be formed with a chamfer 125 at the lower end of the head portion 122a of the latch 122. As the chamfer 125 is formed with a predetermined inclination at a position in contact with a corner of the coupling groove 112 and the receptacle contact T1 when the latch 122 is inserted into the coupling groove 112, the latch 122 may be prevented from being hit or caught while the first TPA member 12 is rotating to the locked position and may be inserted into the coupling groove 112. In addition, when the receptacle contact T1 is not completely installed at a designated position in the first TPA member 12, the latch 122 may be pushed into the coupling groove 112 by the inclination of the chamfer 125 in a state where the latch 122 contacts the receptacle contact T1. Simultaneously, the receptacle contact T1 may be pushed into the designated position.

The first TPA member 12 may be formed with a slot 123 to open the first TPA member 12 from the coupling groove 112. The slot 123 may be located such that some of the head portion 122a is exposed to the outside of the coupling groove 112 when the latch 122 of the first TPA member 12 is inserted into the coupling groove 112. For example, the slot 123 may be on the upper end of the head portion 122a of the latch 122. However, the shape and position of the slot 123 are not limited by the diagrams. According to an embodiment, as the first TPA member 12 is formed with the slot 123, the first TPA member in the locked state may be opened again when the receptacle contact T1 needs to be reworked or repositioned.

In addition, the first TPA member 12 may be formed with a barrier rib 124. In the barrier rib 124, the head portion 122a may protrude more outward (i.e., forward) than the coupling groove 112 when the latch 122 is inserted into the coupling groove 112. This prevents the receptacle contact T1 from being exposed to the outside and from contacting a finger of a person during an operation of locking the first TPA member 12. For example, the barrier rib 124 may extend from the head portion 122a of the latch 122 substantially in parallel to the coupling groove 113 along the transverse direction of the head portion 122a. However, the shape and position of the barrier rib 124 are not limited by the figures.

In addition, a bridge 114 may be formed on one side of the coupling groove 112 so that the first TPA member 12 may not be lifted or locked by an unintended external force. The bridge 114 may be formed to connect an edge of the coupling groove 112 to the head portion 122a of the latch 122. For example, two bridges may be formed. However, the shape and position of the bridge 114 are not limited by the ones in the figures. The bridge 114 enable simultaneously forming the first TPA member 12 integrally with the plug body 11, and may make the first TPA member 12 maintain an open state with respect to the plug body 11. In addition, the bridge 114 may be transformed or cut after the first TPA member 12 couples to the plug body 11 such that the bridge 114 may be accommodated in a pocket 115 as described below.

The pocket 115 may be formed in a predetermined step shape around the coupling groove 112. However, the shape of the pocket 115 may be not limited to the ones in the figures. For example, the pocket 115 may be formed as a predetermined step or space on the edges of both sides of the coupling groove 112 so that the bridge 114 may be accommodated in the pocket 115 when the first TPA member 12 is inserted into the coupling groove 112. In addition, the pocket 115 may have a variety of shapes to accommodate the bridge 114.

The first TPA member 12 may check or identify whether the receptacle contact T1 is installed at a designated position and also push, into the plug body 11 of the designated position, the receptacle contact T1 that is not installed at the designated position, such that the receptacle contact T1 may remain at the designated position.

A description of a TPA member (hereinafter, referred to as a second TPA member 22) provided in the cap 20 is provided. The second TPA member 22 may be substantially the same as the first TPA member 12 except for some components, and the same terms may be used for the same components.

The cap housing 21 may be formed with a coupling slot 212 in which some of a plurality of tab contacts T2 may be exposed and the second TPA member 22 may be inserted and fixed. The coupling slot 212 may be formed with a locking bump or protrusion 213 engaging with a latch 222 of the second TPA member 22. A hinge portion 221, which is one end of the second TPA member 22, may be fixed to and hinged with respect to the cap housing 21 and the latch 222, which is the other end of the second TPA member 22, may extend toward the first end 21a and be a free end. The latch 222 may engage with the locking bump 213 of the coupling slot 212.

The second TPA member 22 may be fixed to a side of the second end 21b of the cap housing 21. For example, an edge portion of the side of the second end 21b of the cap housing 21 may be formed to protrude at a predetermined height, and the hinge portion 221 may connect to the protruding portion at an obtuse angle in order to form an inclination at a predetermined angle with respect to a surface of the cap housing 21.

According to an embodiment, since the hinge portion 221 of the second TPA member 22 is formed to have an inclination, when the second TPA member 22 is pressed, the second TPA member 22 may be rotated and inserted into the coupling slot 212. In addition, the second TPA member 22 may be transformed by its own elasticity such that the latch 122 may be inserted into the coupling slot 212 and coupled to the locking bump 113, and the second TPA member 22 may be prevented from being unlocked at the final locked position. In addition, when the latch 122 is inserted into the coupling slot 212, a chamfer 125 may be formed at the lower end of a head portion 222a which is positioned to contact an edge of the coupling slot 212.

The second TPA member 22, not similar to the first TPA member 12, is illustrated without a slot and a barrier rib. However, the second TPA member 22 is not limited to the ones in the diagrams. The second TPA member 22 may also be formed with a slot for reopening and a barrier rib for preventing a head portion from being exposed to the outside.

A bridge 214 may be formed at the central portion of the second TPA member 22 and at an edge portion of the coupling slot 212 to prevent the second TPA member 22 from being opened unintentionally. However, the number and position of the bridges 214 may not be limited to the ones in the figures.

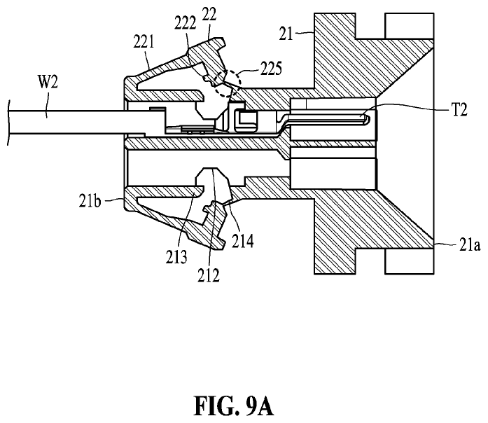

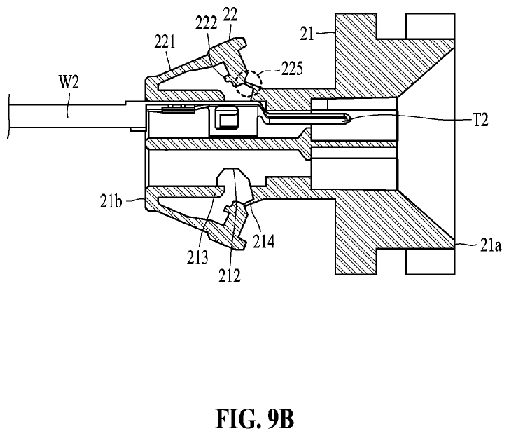

An operation of the second TPA member 22 is described with reference to FIGS. 9A and 9B. Although an example of the second TPA member 22 is described below, the example may also apply to an operation of the first TPA member 12. First, referring to FIG. 9A, in the case of the tab contact T2 installed at a designated position, when the second TPA member 22 is closed, the latch 222 may be completely inserted into the coupling slot 212. However, as shown in FIG. 9B, when the tab contact T2 is not installed at a designated position, for example, installed upside down, interference may occur between the tab contact T2 and the latch 222 in the coupling slot 212 such that the latch 222 may not be completely inserted into the coupling slot 212 and the second TPA member 22 may not be completely closed. Therefore, during the operation of closing the second TPA member 22, whether the tab contact T2 is sitting at a designated position of the cap housing 21 may be checked or identified based on whether the second TPA member 22 is closed. In addition, when the latch 222 is inserted into the coupling slot 212, the second TPA member 22 may contact and press the tab contact T2 such that the tab contact T2 may be pushed into and maintained at the designated position in the cap housing 21. However, unlike the embodiment described above, a second TPA member 32 may couple to the rear of the cap housing 21.

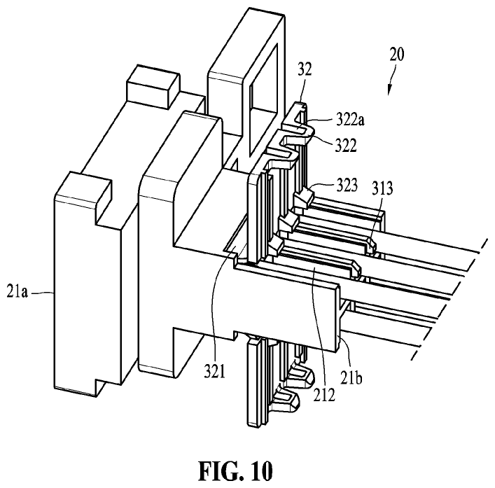

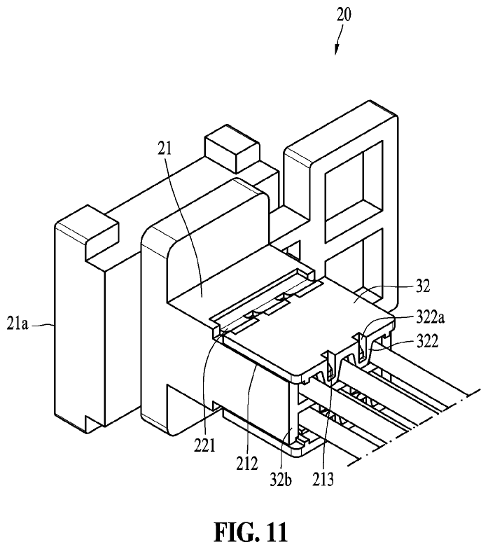

The second TPA member 32 according to a modified embodiment is described with reference to FIGS. 10 and 11. A coupling slot 212′ may be formed in the cap housing 21 to expose the tab contact T2. The second TPA member 32 may approximately have a plate shape covering the surface where the coupling slot 212′ is formed. In addition, the second TPA member 32 may be formed with a hinge portion 321, in which the fixed end that is fixed to the cap housing 21 is hinged, and a latch 322, which may engage with the rear of the second end 21b in the free end extending towards the second end 21b. In addition, the second TPA member 32 may be formed with a guide protrusion 323 that is inserted into the coupling slot 212′ and then contacts and pressures the tab contact T2 at a position adjacent to the hinge portion 321. In the process of closing the second TPA member 32 with respect to the cap housing 21, when the tab contact T2 is not properly sitting at a designated position, the guide protrusion 323 may not be completely inserted into the coupling slot 212′ in the second TPA member 32. Based thereon, whether the tab contact T2 is properly sitting at the designated position may be identified.

When the second TPA member 32 couples to the cap housing 21, the upper surface of the second TPA member 32 may be the same as the surface of the cap housing 21, so that the second TPA member 32 may not protrude from the cap housing 21. The second TPA members 32 may be provided on two surfaces of the cap housing 21 to be opposite to each other. However, examples are not limited by the figures, and the second TPA member 32 may be provided at only one position.

The hinge portion 321 of the second TPA member 32 may be formed to couple to the lower side of the second TPA member 32. Therefore, when the second TPA member 32 couples to the cap housing 21, as shown in FIG. 9, the hinge portion 321 may not protrude beyond the second TPA member 32.

The latch 322 of the second TPA member 32 may be formed to couple to the rear of the second end 21b of the cap housing 21. In addition, the latch 322 may have a shape extending substantially downward to cover the rear of the second end 21b when the latch couples to the second end 21b of the cap housing 21. In addition, the latch 322 may be formed with a locking opening 322a to have, for example, a ring shape. A locking bump or protrusion 213 may be formed on the second end 21b and may protrude rearward so as to be inserted into and coupled to the locking opening 322a of the latch 322. The diagrams illustrate two latches 322 and two locking bumps 213 but are examples for convenience of explanation. The number of latches 322 and the number of locking bumps 213 may be three or more or only one.

Similar to the first TPA member 12, the second TPA member 32 may check whether the tab contact T2 is installed at a designated position, may position, into the cap housing 21 of the designated position, the tab contact T2 that is not installed at the designated position, and may maintain the tab contact T2 at the designated position.

When the second TPA member 32 rotates such that the latch 322 engages with the locking bump 213 in the rear of the cap housing 21, the latch may press, contact, and thus support the tab contact T2. When the tab contact T2 is not installed at the designated position, the tab contact T2 may protrude to the outside of the cap housing 21 and interfere with the latch 322. In such a case, the second TPA member 32 may not be completely closed. Therefore, whether the tab contact T2 is properly positioned may be checked by a locking operation of hinging the second TPA member 32. In addition, since the latch 322 of the second TPA member 32 presses and contacts the tab contact T2, the tab contact may be pushed into the cap housing 21 and may remain at the designated position inside the cap housing.

According to embodiments, since the TPA members 12, 22, and 32 are provided in the plug 10 and the cap 20, whether the receptacle and tab contacts T1 and T2 are properly sitting in the plug 10 and the cap 20 may be checked. The receptacle and tab contacts T1 and T2, which are not sitting at the designated position, may be pushed or biased into designated positions.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector assembly comprising:
a body having a plurality of contacts and defining a coupling groove exposing some of the plurality of contacts; and
an elastic terminal position assurance (TPA) member including a hinge portion and a latch, and adapted to indicate whether the plurality of contacts are sitting at designated positions, the hinge portion is hinged with respect to the body on one end of the TPA member, and the latch is formed such that the other end of the TPA member engages with the coupling groove.

2. The connector assembly of claim 1, wherein the latch has an inclination with respect to a surface of the body based on the hinge portion.

3. The connector assembly of claim 1, wherein the body includes an outside wall at a portion coupling to the hinge portion, and the hinge portion includes a movable portion formed with a break-away portion defined by the outside wall.

4. The connector assembly of claim 1, wherein the TPA member defines a chamfer at a lower end of a head portion of the latch.

5. The connector assembly of claim 1, wherein the TPA member defines a slot in a head portion of the latch to reopen the TPA member.

6. The connector assembly of claim 1, wherein the TPA member defines a barrier rib that protrudes forward in a head portion of the latch.

7. The connector assembly of claim 1, wherein a locking protrusion protrudes into the coupling groove for engaging with the latch, and a bridge connecting a head portion of the latch to the body is formed at an edge opposite to the locking protrusion.

8. The connector assembly of claim 7, wherein a pocket accommodating the bridge is formed around the coupling groove when the coupling groove receives the TPA member.

9. A connector assembly comprising:
a plug having with a plurality of first contacts;
a cap having a plurality of second contacts and adapted to receive the plug; and
a terminal position assurance (TPA) member hinged with respect to each of the plug and the cap, and adapted to identify whether each of a plurality of contacts is sitting at a designated position.

10. The connector assembly of claim 9, wherein:
a coupling groove is formed in the plug to expose some of the plurality of first contacts and a locking protrusion is formed to protrude in the coupling groove; and
a first TPA member provided in the plug comprises:
a first hinge portion fixed to and hinged with respect to the plug on one end of the first TPA member; and
a first latch inserted into the coupling groove on a free end of the first TPA member, and adapted to press and contact the plurality of first contacts in a direction opposite to a direction in which the plurality of first contacts are disengaged from the plug as the first latch engages with the locking protrusion in the coupling groove.

11. The connector assembly of claim 10, wherein the first latch is formed with the coupling groove in a portion opposite to the locking protrusion and includes a chamfer at a position contacting the plurality of first contacts.

12. The connector assembly of claim 10, wherein the first TPA member is provided with the first latch having an inclination with respect to a surface of the plug based on the first hinge portion.

13. The connector assembly of claim 10, wherein an outside wall exposed to the outside when the plug is coupled to the cap is formed in the plug, and the first hinge portion comprises a movable portion formed with a break-away portion defined on the outside wall.

14. The connector assembly of claim 10, wherein the first TPA member defines a slot that is in a head portion of the first latch to reopen the first TPA member.

15. The connector assembly of claim 10, wherein the first TPA member defines a barrier rib that protrudes forward in a head portion of the first latch.

16. The connector assembly of claim 10, wherein a bridge connects a head portion of the first latch to a plug body, and is formed at an edge opposite to the locking protrusion in the coupling groove.

17. The connector assembly of claim 16, wherein a pocket accommodating the bridge is formed around the coupling groove when the coupling groove receives the first TPA member.

18. The connector assembly of claim 9, wherein:
the cap defines a coupling slot exposing some of the plurality of second contacts, and a second locking protrusion protrudes in the coupling slot, and
a second TPA member provided in the cap comprises a second hinge portion fixed to and hinged with respect to the cap on one end of the second TPA member, and a second latch inserted into the coupling slot of the cap on a free end of the second TPA member, and adapted to press and contact the plurality of second contacts in a direction opposite to a direction in which the plurality of second contacts are disengaged from the cap as the second latch engages with the second locking protrusion in the coupling slot.

19. The connector assembly of claim 9, wherein the cap defines a coupling slot exposing some of the plurality of second contacts and a second locking protrusion protrudes on a rear of the cap, and a second TPA member provided in the cap to cover the coupling slot and is formed such that a second hinge portion on one end of the second TPA member is fixed to and hinged with respect to the cap and a second latch extending from a free end of the second TPA member engages with the second locking protrusion.

20. The connector assembly of claim 19, wherein the second hinge portion couples to a lower portion of the second TPA member.
